(19) United States
(12) Patent Application Publication
(10) Pub. No.: US 2026/0063912 A1
(43) Pub. Date: Mar. 5, 2026

(54) Facial Interface for Electronic Device

(71) Applicant: Apple Inc., Cupertino, CA (US)

(72) Inventors: Paul X. Wang, Cupertino, CA (US); Benjamin W. Penner, Santa Cruz, CA (US); Huizhong Li, San Jose, CA (US); Richard P. Howarth, Lake Forest, IL (US)

(21) Appl. No.: 19/215,801

(22) Filed: May 22, 2025

Related U.S. Application Data
(60) Provisional application No. 63/688,591, filed on Aug. 29, 2024.

(51) Int. Cl. G02B 27/01

(52) U.S. Cl. CPC G02B 27/0176; G02B 27/0149; G02B 27/0172; G02B 27/0179; G02B 2027/0161; G02B 2027/0169

(57) ABSTRACT

A head-mountable display device can include a display portion with a frame and a bumper. The bumper can be configured to contact a user's head when the head-mountable display device is donned. The bumper can include multiple sections configured with different material properties, include different characteristics, provide different user experiences, and to maintain a comfortable and effective distance between the lenses or displays of the display device and a user's eyes.

### CROSS-REFERENCE TO RELATED APPLICATION

This application claims the benefit of U.S. Provisional Application No. 63/688,591, filed 29 Aug. 2024, entitled “FACIAL INTERFACE FOR ELECTRONIC DEVICE,” the entire disclosure of which is hereby incorporated by reference.

### FIELD

The present disclosure relates generally to head-mountable display devices. More particularly, the present disclosure relates to a facial interface for a head-mountable display device.

### BACKGROUND

Recent advances in portable computing have led to an increase in the use of head-mounted devices. For extended use, comfort is a critical factor in user adoption of head-mounted devices. A key component impacting comfort is the facial interface, which rests against the user's face and transmits the weight of the head-mounted device. Current head-mountable display devices are often heavy and lack points of contact on the heads of users, leading to pressure points and discomfort for users with different facial features and head shapes. Additionally, the distance between a display located within a head-mountable display device and the face of a user can affect the quality of the media displayed to the user, the need for a user to focus and refocus the user's eyes on the display, the amount of airflow between the user's face and the head-mountable display device, and other comfort and optimization factors. Therefore, what is needed in the art is a head-mountable display device including a facial interface that supports the head-mountable display device on the head of a user in a comfortable manner.

### SUMMARY

In at least one example of the present disclosure, a head-mountable display device can include a frame. In some examples, the head-mountable display device can also include a display coupled to the frame, a lens coupled to the frame adjacent the display, and a facial interface extending from the frame. In some examples, the facial interface includes a bumper and a nose piece, the bumper includes a first portion and a second portion, the first portion is more firm than the second portion, and the lens is disposed between the nose piece and the bumper. In some examples, the frame defines a first gap between the facial interface and a user face when donned. In some examples, the facial interface defines an open space along the frame between the bumper and the nose piece, the open space allowing ambient light to reach the lens. In some examples, the bumper is removable. In some examples, the bumper is adjustable relative to the frame. In some examples, the bumper is a first bumper, and the head-mountable display device further includes a second bumper spaced apart from the first bumper and configured to be aligned with a zygomatic bone when the head-mountable display device is donned. In some examples, the first portion abuts the second portion. In some examples, the head-mountable display device defines a first gap between the first portion and the second portion. In some examples, the bumper extends towards a user face beyond the lens.

In at least one example of the present disclosure, a head-mountable device can include a frame. In some examples, the head-mountable device can also include a lens coupled to the frame, and a bumper coupled to the frame. In some examples, the bumper is disposed above the lens when the head-mountable display device is donned by a user, the bumper defines a first portion, a second portion, and a third portion, the first portion and the second portion are more firm than the third portion, and the third portion is disposed between the first portion and the second portion. In some examples, the bumper defines a first gap between the frame and a user face on a first side of the bumper through which light enters a field of view of a user when the head-mountable device is donned, and a second first gap between the frame and a user face on a second side of the bumper opposite the first side and through which light enters the field of view of the user when the head-mountable device is donned. In some examples, at least one of the first portion or the second portion defines a first gap between the head-mountable device and the face of a user when donned. In some examples, the third portion at least partially overlaps at least one of the first portion or the second portion. In some examples, the first portion is disposed between at least some of the third portion and the frame. In some examples, the frame defines multiple regions configured to receive the bumper.

In at least one example of the present disclosure, a display portion can include a frame. In some examples, the display portion can also include a lens secured to the frame, and a facial interface including a first protrusion adjacent the lens and a second protrusion adjacent the lens and separate from the first portion. In some examples, the lens is disposed between the first protrusion and the second protrusion, and the first protrusion is firmer than the second protrusion. In some examples, the display portion can include a third protrusion defined by the facial interface, the third protrusion being softer than at least one of the first protrusion or the second protrusion. In some examples, the third protrusion is located adjacent to the first protrusion. In some examples, at least one of the first protrusion or the second protrusion includes a non-Newtonian fluid bladder. In some examples, the display portion includes a second display secured to the frame.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a perspective view of an example of a head-mountable display device;

FIG. 2 shows another perspective view of an example of a head-mountable display device;

FIG. 3A shows an example of a display portion in a one configuration;

FIG. 3B shows an example of a display portion in another configuration;

FIG. 3C shows an example of a display portion in another configuration;

FIG. 3D shows an example of a display portion in a yet another configuration;

FIG. 4A shows an example of a facial interface in on configuration;

FIG. 4B shows an example of a facial interface in another configuration;

FIG. 5 shows a side view of an example of a head-mountable display device; and

FIG. 6 shows another example of a display portion in another configuration.

### DETAILED DESCRIPTION

Reference will now be made in detail to representative examples illustrated in the accompanying drawings. It should be understood that the following descriptions are not intended to limit the examples to one preferred embodiment. To the contrary, it is intended to cover alternatives, modifications, and equivalents as can be included within the spirit and scope of the described examples as defined by the appended claims.

The following disclosure relates to display portions and facial interfaces for head-mountable display devices. Current head-mountable display devices can be heavy and lack consistent points of contact on the heads of users, leading to ill-fitting devices, pressure points, and discomfort for users with different facial features and head shapes. The contact points on the head or face of the user can affect the operation and comfort of the system during use. Additionally, the distance between a display located within a head-mountable display device and the face of a user can affect the quality of the media displayed to the user, the need for a user to focus and refocus the user's eyes on the display, the amount of airflow between the user's face and the head-mountable display device, and other comfort and optimization factors. Accordingly, devices and systems described herein include facial interfaces and contact point features that comfortably conform to a wide range of facial shapes and sizes while remaining usable. The devices, systems, and methods of the present disclosure improve user comfort and broaden the potential user base for head-mounted devices.

The various examples of head-mountable display devices described herein can include a display portion and one or more securement arms coupled to the display portion. In some examples, the display portion can include a frame and various parts coupled to the frame. For example, at least some head-mountable display devices described herein can include at least one display coupled to the frame. The display can be configured to produce visual media for user consumption. The display can be a screen, a projection, or another means of displaying content. In some examples, the display portion can include a bumper and one or more lenses. The lenses can be coupled to the frame or the bumper and can change a characteristic of the media produced at the display as viewed by a user. In some examples, a lens can map the visual media displayed at the display to the eyes of a user. In other examples, a lens can be a corrective lens. The lenses described herein can be configured to provide a clear, desirable user experience to a variety of face shapes, eye conditions, and visual abilities.

The bumper can be coupled to the frame and can extend from the frame toward the face of a user when the head-mountable display device is donned. In some examples, the bumper can include more than one portion or section. In some examples, one portion or section of the bumper can be more firm than another portion or section. Sections of different firmness can allow some portions of the bumper to conform to the face-shape of a user, while other portions can remain firm or rigid when external forces are applied. A softer portion of the bumper can facilitate a comfortable user experience and a firm portion of the bumper can provide rigidity to the bumper to maintain a position of the user's eyes relative to the head-mountable display device for an enhanced comfort level and user experience. In some examples, the firm portions of the bumper can be configured to be positioned over the brow bone and/or zygomatic bone of a user. Less firm portions of the bumper can be configured to be positioned over the nose of a user, over the forehead of a user, or over another portion of a user's face or head. In some examples, one or more portions of the bumper can contact the face of a user. In some examples, one or more portions of the bumper can define a gap between the display portion and the face of a user. Various portions of the bumper can abut one another, define a gap between portions, overlap one another, or be otherwise configured relative to one another. In some examples, the head-mountable display devices described herein can include various electronic components such as processors, batteries, memory devices, speakers, sensors, camera, and more. The head-mountable display devices described herein can also include wireless functionality.

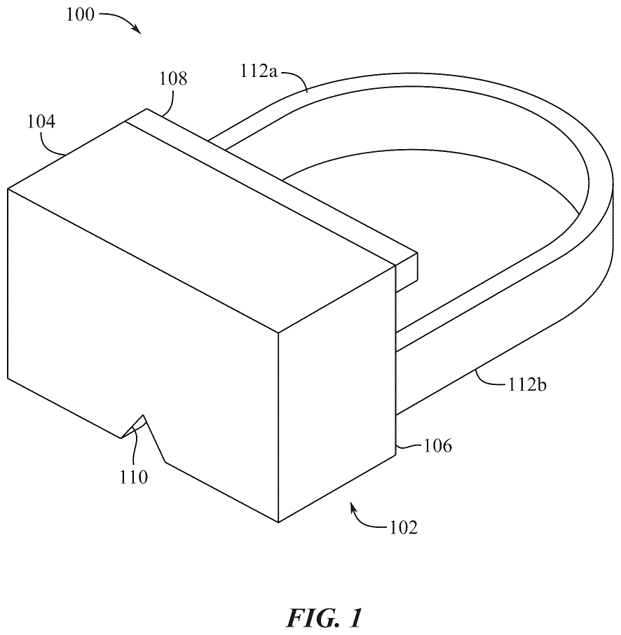

These and other embodiments are discussed below with reference to FIGS. 1-6. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 shows a perspective view of a head-mountable display device 100. In some examples, the head-mountable display device 100 can be a head-mountable device configured to display media to a user. The head-mountable display device 100 can include a display portion 102, a frame 104, a facial interface 106, and one or more securement arms 112a-b coupled to the frame 104. The head-mountable display device 100 can be configured to be mounted to the head of a user and display visual media to the user. In some examples, the visual media displayed by the head-mountable display device 100 can include videos, live streams, websites, recordings, virtual reality settings, television, or other forms of visual media. In some examples, the securement arms 112a-b can be configured to rest on the cars of a user. The securement arms 112a-b can be configured to support at least a portion of the weight of the head-mountable display device 100. The head-mountable display device 100 can also include a nose piece 110. The nose piece 110 can be configured to rest on the nose of a user and at least partially support the head-mountable display device 100. The head-mountable display device 100 can be configured to provide a comfortable user experience by utilizing a variety of polymers, ceramics, metals, or composite materials. In some examples, the materials used to construct the head-mountable display device 100 can include silicone, foam, fabric, aluminum, steel, plastics, or other materials.

In some examples, the head-mountable display device 100 can include various electrical and electronic components. For example, the head-mountable display device 100 can include one or more processors, speakers, batteries, screens, projectors, motors, linear actuators, cameras, sensors, wires, and other components. The various electrical and electronic components can be disposed within various parts of the head-mountable display device 100. For example, at least one of the securement arms 112a-b can include a battery and/or a speaker. The display portion 102 can include a processor, camera, and screen. The electronic components disposed in the securement arms 112a-b can be electrically coupled to the electronic components disposed within the display portion 102. The electrical and electronic components included in the head-mountable display device 100 can produce an immersive and desirable user experience.

In some examples, the head-mountable display device 100 can also include a bumper 108. The bumper 108 can be configured to extend toward and/or contact a portion of a user's head when the head-mountable display device 100 is in use. In some examples, the bumper 108 and the nose piece 110 can form a facial interface 106. In some examples, the bumpers 108 can be configured to contact the forehead of a user. The bumper 108 can be configured to enhance the user's experience by increasing comfort, improving stability of the head-mountable display device 100, and/or supporting the head-mountable display device 100. In some examples, the bumper 108 can be a padded portion or a contoured portion. For example, the bumper 108 can be molded to the shape of user's face or can deform to fit the face of a user when the head-mountable display device 100 is donned. Likewise, the nose piece 110 can also be a padded portion or a contoured portion. In some examples, at least the nose piece 110 or the bumper 108 can be a combination of padded and contoured portions. In some examples, the bumper 108, nose piece 110, or combination thereof can define the distance between the display portion 102 and the face of a user when the head-mountable display device 100 is donned.

In at least one example, the facial interface of the device 100, which can include the bumper 108 and the nose piece 110, can extend toward the user's head and face from the display portion 102 and/or frame 104 thereof to ensure certain other components of the device 100 maintain an appropriate and comfortable distance relative to the user's face, for example the user's eyes, during operation. For example, the display portion 102 can include one or more display screens and/or lenses, which will be shown in other figures and described in more detail below, which can be aligned with the user's eyes for displaying information thereto. In at least one example, the bumper 108 can extend toward the user's face beyond the degree to which the lens and/or displays of the display portion 102 extend toward the user's face. In this way, if or when the device 100 is pressed on or toward the user's face during operation, the distance between the lens and/or displays and the eyes can be optimized for use and comfort when the bumper 108 contacts the user's forehead or other area of the head and face around the eyes first. As will be described in greater detail below, the bumper 108 can include multiple portions and sections formed of materials and geometries having differing firmness. The less firm portions or sections of the bumper 108 can be configured to contact the user's head and face first for comfort. The more firm portions or sections of the bumper 108 can underlie the less firm portions and/or form an underlying structure of the bumper 108 to prevent excessive deformation of the bumper 108 and undesired translation of the display portion 102, thereby enhancing performance and comfort of the system.

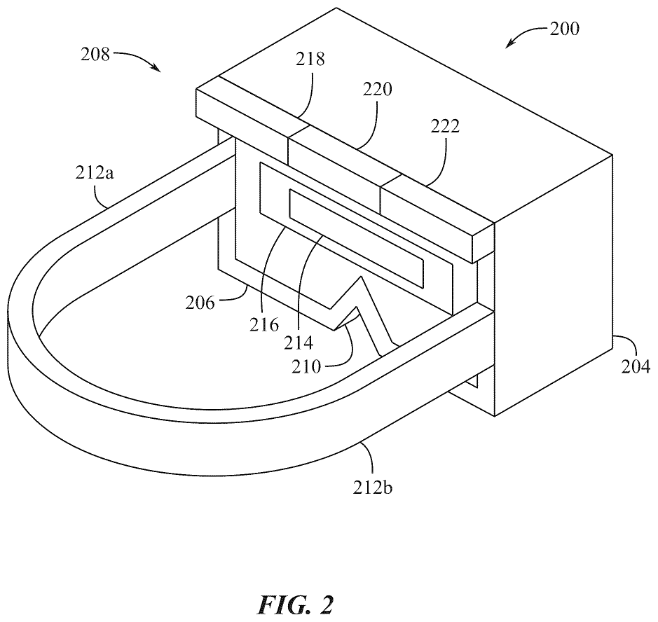

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1. More examples of head-mountable display devices with facial interfaces are given below in reference to FIG. 2.

FIG. 2 shows another example of a head-mountable display device 200. The head-mountable display device 200 can include various components configured to display visual media to a user, improve the comfort of the user experience, and improve the interface between the face of a user and the head-mountable display device 200. For example, the head-mountable display device 200 can include a frame 204, a facial interface 206 extending from the frame 204, and securement arms 212a-b coupled to the frame 204. The facial interface 206 can include a bumper 208 and a nose piece 110. The nose piece 210 and the bumper 208 can be configured to extend toward and/or abut the face of a user when the head-mountable display device 200 is donned. The facial interface 206 and the securement arms 212a-b can each be configured to support at least a portion of the weight of the head-mountable display device 200.

The head-mountable display device 200 can also include a display 214 coupled to the frame 204 and a lens 216 coupled to the frame 204 adjacent to the display 214. In some examples, the head-mountable display device 200 can include multiple displays. In some examples, the head-mountable display device 200 can also include multiple lenses. The display 214 can be configured to present visual media to a user. For example, the display 214 can be a screen. In some examples, the display 214 can be an OLED screen, an LED screen, an LCD screen, or another type of screen. In other examples, the display 214 can be a surface onto which an image is projected. In some examples, light from the display 214 can travel through the lens 216 before being perceived by a user. The lens 216 can be configured to change a characteristic of the light from the display 214. For example, the lens 216 can be configured to magnify or focus the media produced at the display 214. In other examples, the lens 216 can be configured to change some portions of the media produced at the display 214. For example, the lens 216 can change the proportions of the media produced at the display 214. In this manner, the lens 216 and display 214 can facilitate a desirable user experience by producing high-quality, engaging, and clear media for a user to perceive.

In some examples, the bumper 208 can be disposed above the lens 216 when the head-mountable display device 200 is donned by a user. The lens 216 can also be disposed between the nose piece 210 and the bumper 208. The bumper 208 can be configured to contact the forehead or brow area of a user when the head-mountable display device 200 is donned. In some examples, the bumper 208 can include a first portion 218, a second portion 222, and a third portion 220. The first portions 218 and the second portion 222 can be more firm than the third portion 220. Firmness can be the opposite of soft. For example, firmness can be determined by the toughness of a material, the geometry of the bumper 108, the rigidity, the elasticity, the amount of deformation given a certain force, a relative amount of force per unit area applied to achieve a known deflection or deformation, an internal pressure measurement, or other metrics. In other examples, firmness can be quantified by a component's resistance to an input force.

In the present example, the first portion 218 and the second portion 222 can be configured to resist more force than the third portion 220 or deform less in response to the same applied force. The first portion 218 and the second portion 222 can provide structural rigidity to the bumper 208. In some examples, the third portion 220 can be configured to be less firm than the first portion 218 and the second portion 222, and to be more comfortable when contacting the user's head. For example, the third portion 220 can be configured to conform to the face of a user, providing a comfortable user experience. The third portion 220 can be disposed between the first portion 218 and the second portion 222. In some examples, the third portion 220 can be configured to contact the head of a user at a location with more curvature than the location at which the first portion 218 and the second portion 222 contact the head of a user. The third portion 220 can provide a comfortable user experience by conforming to the area of the user's head with more curvature. The first portion 218 and the second portion 222 can also control the distance between the frame 204 and the face of a user by remaining firm, and not significantly deforming in response to pressure from the face of the user. Controlling the distance between the frame 204 and the face of a user can improve the comfort of the device so the lens 216 and display 214 maintain an appropriate distance relative to the user's eyes when the device 200 is donned. Controlling the distance between the frame 204 and the face can also improve the visual characteristics of the head-mountable display device 200, stabilize the media produced at the display 214, and minimize the need for the user to refocus on the display 214.

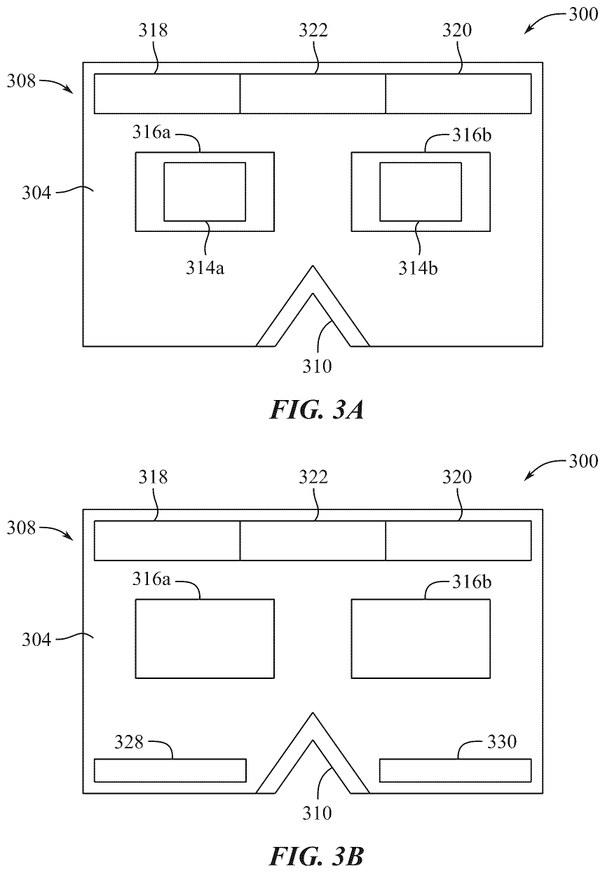

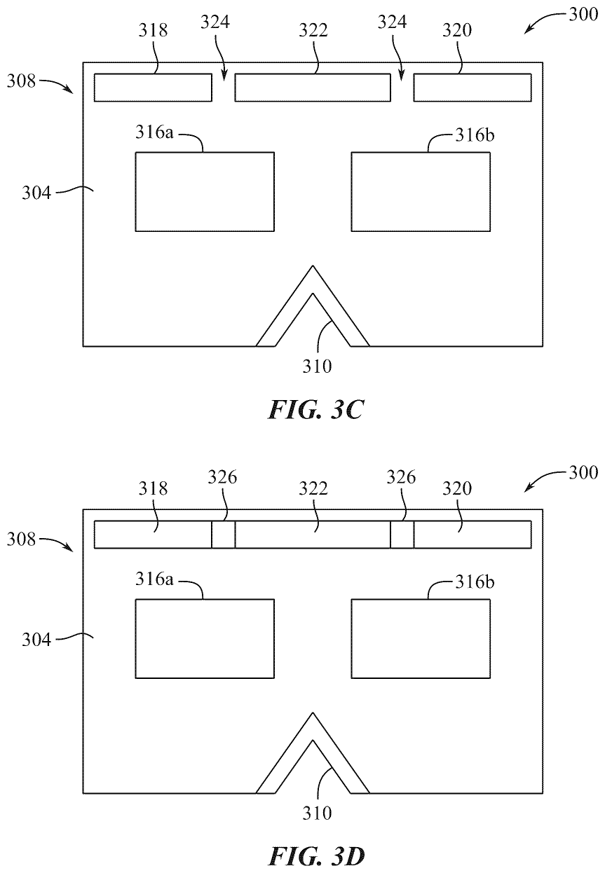

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, cither alone or in any combination, in the example of the devices, features, components, and parts shown in FIG. 2. More examples of display portions including bumpers in several different configurations are given below in reference to FIGS. 3A-3D.

FIGS. 3A-3D show a display portion 300 in different configurations. The display portion 300 shown can include a frame 304, a bumper 308, a nose piece 310, and lenses 316a-b. In some examples, the lenses 316a-b can be coupled to the frame 304. In some examples, the display portion 300 can include a first display 314a and a second display 314b. FIG. 3A shows the display portion 300 in one configuration. The bumper 308 shown in FIG. 3A can include a first portion 318, a second portion 320, and a third portion 322. In some examples, the first portion 318 and the second portion 320 can be more firm than the third portion 322. The first portion 318 and the second portion 320 can both contact the third portion 322. In some examples, the first portion 318 can be positioned adjacent to the third portion 322. As shown in FIG. 3A, the lenses 316a-b can be disposed between the nose piece 310 and the bumper 308.

In some examples, the bumper 308 can be removable from the frame 304. In one example, the bumper 308 is removable as part of its normal function such that removing the bumper 308 from the frame 304 does not break, damage, or otherwise alter the functionality of the bumper 308. The bumper 308 can be intended to be removed. In one example, the bumper 308 can be removable via a mechanical mechanism. Other examples can include magnetic, hook-and-loop, or other mechanisms removably securing the bumper 308 to the frame 304. A removable bumper 308 can allow the bumper 308 to be interchangeable. For example, a user can change from one bumper 308 to another bumper 308 for improved fit, position, size, or other characteristics. A removable bumper 308 can also allow the display portion 300 to be more easily packaged, fit into a case, and transported. In some examples, the bumper 308 can be adjustable relative to the frame 304. For example, the bumper 308 can be translatable relative to the frame 304 in a first, vertical direction and a second, horizontal direction. The bumper 308 can also extend or retract from the frame 304. In some examples, the bumper 308 can be rotatable relative to the frame 304. The bumper 308 can also tilt relative to the frame 304 to change the angle at which the bumper 308 contacts the frame 304. The bumper 308 can be secured to the frame 304 via rails, joints, detent mechanisms, or other forms of adjustable securement. In some examples, the bumper 308 can be manually adjustable. The bumper 308 can be adjustable via a dial, detent positions, screws, knobs, or other adjustment mechanisms. In some examples, the adjustability of the bumper 308 can be motorized. In some examples, adjustment of the bumper 308 can be controlled via buttons or through a user interface. In other examples, the bumper 308 can be automatically adjustable. The bumper 308 can be adjustable based on facial data such as a three-dimensional model of a user's face, profile data, or the bumper 308 can adjust to a user's face based on preset positions.

FIG. 3B shows another example of a display portion 300. In some examples, the bumper 308 can be a first bumper, and the display portion 300 can further include at least a second bumper 328. The second bumper 328 can be spaced apart from the first bumper 308, and can be generally aligned with the zygomatic bone of a user when the display portion 300 is donned. In some examples, the display portion 300 can include a third bumper 330 aligned with the zygomatic bone opposite the second bumper 328. The second bumper 328 and the third bumper 330 can be configured to support at least a portion of the weight of the display portion 300 against the face of a user. Additionally, the second bumper 328 and the third bumper 330 can be configured to be more firm than the third portion 322 in some examples. In other examples, the second bumper 328 and the third bumper 330 can be configured to be softer than the first portion 318. In some examples, the bumper 308 can be a first protrusion, the second bumper 328 can be a second protrusion. The bumper 308 and the second bumper 328 can be included in a facial interface. In some examples, the first protrusion can be disposed adjacent to the lens 316a and the second protrusion can be disposed adjacent to the lens 316a, the lens 316a disposed between the first protrusion and the second protrusion.

In examples of bumpers described herein, including bumpers 108, 208, 308, 328, 330, and other bumpers described herein, each bumper can extend away from the frame or display portion 300 toward the user's face beyond (e.g., to a greater extent than) the lenses 316a-b and displays 314a-b to ensure optimized distance between the user's eyes and the lenses 316a-b and/or displays 314a-b for comfort and performance.

FIG. 3C shows another example of a display portion 300. The display portion 300 shown in FIG. 3C can also include a bumper 308. The bumper 308 can include a first portion 318, a second portion 320, and a third portion 322. In some examples, the first portion 318 can be separated from the third portion 322 by a first gap 324a. Similarly, the second portion 320 can be separated from the third portion 322 by a second gap 324b. In some examples, the gaps 324a-b can allow the third portion 322 to expand or contract laterally in response to forces conforming the third portion 322 to the head of a user. Air can also flow through the gaps 324a-b, which can cool the face of a user while the display portion is donned. In some examples, the gaps can allow for independent removal or adjustment of the first portion 318, the second portion 320, and the third portion 322. For example, independent removal of the first portion 318 can allow a user to exchange the first portion 318 for another portion with a different firmness, curvature, size, or material. In some examples, the first portion 318 can also translate horizontally toward the third portion 322 without adjustment of the third portion 322. Independent adjustment of the portions 318, 320, and 322 can allow the display portion 300 to conform to a variety of facial structures, face shapes, and head sizes for optimal comfort.

FIG. 3D shows another example of a display portion 300. The display portion 300 shown in FIG. 3D can be substantially similar to the display portion 300 shown in FIG. 3A, with the addition of transition portions 326a, 326b disposed between the first portions 318 and the third portion 322, and between the second portion 320 and the third portion 322. The transition portions 326a-b can allow for a smoother transition from the firmer first portion 318 to the softer third portion 322. In some examples, the transition portions 326a-b can be a different material than the first portion 318, the second portion 320, and the third portion 322. In other examples, the transition portions 326a-b can be formed by a blend of the materials of the first portion 318 and the third portion 322. In other examples, the transition portions 326a-b can be formed by a gradual change from one material to another, such as an overlapping portion. The transition portions 326a-b can blend the material properties of the bumper 308, creating a more comfortable user experience.

Any of the features, components, and/or parts, including the arrangements and configurations thereof shown in FIGS. 3A-3D can be included, cither alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 3A-3D.

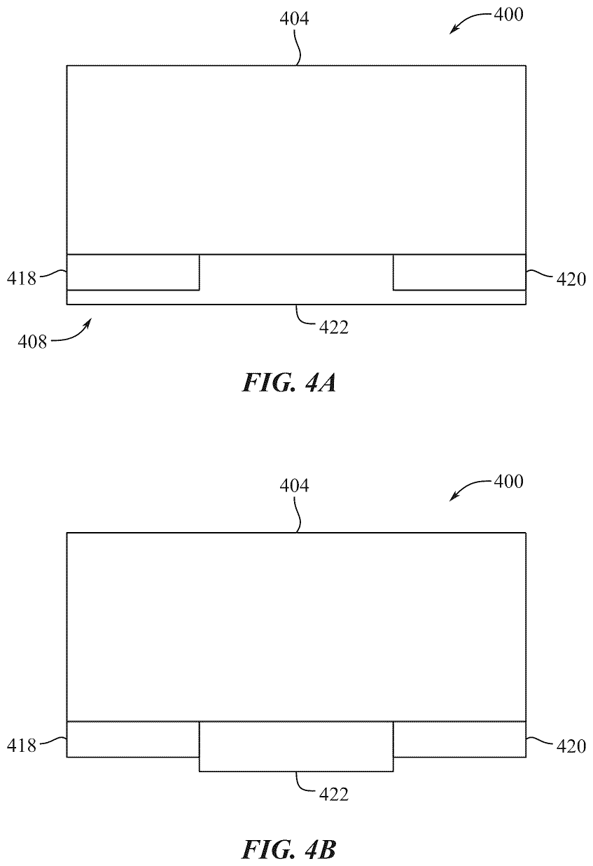

FIGS. 4A-4B show an example of a display portion 400 in different configurations. In some examples, the display portion 400 can include a bumper 408 coupled to a frame 404. In some examples, the bumper 408 can include a first portion 418, a second portion 420, and a third portion 422. FIG. 4A shows the display portion 400 in one configuration. In some examples, the first portion 418 and the second portion 420 can be configured to be more firm than the third portion 422. As shown in FIG. 4A, the third portion 422 can be configured to overlap at least a part of the first portion 418 and/or the second portion 420. In some examples, at least a part of the third portion 422 can be configured to contact the face of a user. The third portion 422, including the portions that can overlap other portions of the bumper 408, can allow for more firm portion of the bumper 408, or a less firm portion of the bumper 408, to contact a user's head. In some examples, at least a portion of third portion 422 can extend from the frame 404. At least a portion of at least first portion 418 or second portion 420 can also be configured to extend from the frame 404. By overlapping at least a portion of the first portion 418 and/or the second portion 420, the third portion 422 can improve the comfort and ergonomics of the display portion 400. In some examples, the third portion 422 can be configured to deform more than the first portion 418 or the second portion 420 in response to pressure exerted on the bumper 408 by the head of a user. In some examples, the bumper 408 can be removably attached to the frame 404. For example, the bumper 408 can be secured to the frame 404 via clips, a hook and loop system, magnets, snaps, or another securement method. In the example shown in FIG. 4A, at least some of the third portion 422 can be disposed between the first portion 418 and the second portion 402. Also, the first portion 418 and the second portion 420 can each be disposed between at least some of the third portion 422 and the frame 404.

FIG. 4B shows the display portion 400 in another configuration. In the configuration shown in FIG. 4B, the third portion 422 can extend from the frame 404 and past at least the first portion 418 or the second portion 420 in a direction extending toward the user's face when the display portion 400 is donned. In some examples, the third portion 422 can be configured to contact the head of a user when in use, while the first portion 418 and the second portion 420 are configured to be spaced apart from the head of a user while in use. In this manner, the third portion 422 can facilitate a comfortable user experience. In some examples, the first portion 418 and the second portion 420 can be configured to contact the head of a user when the third portion 422 is compressed. As described herein, a bumper 408 including a more firm portion and a less firm portion can increase user comfort when the display portion 400 is donned.

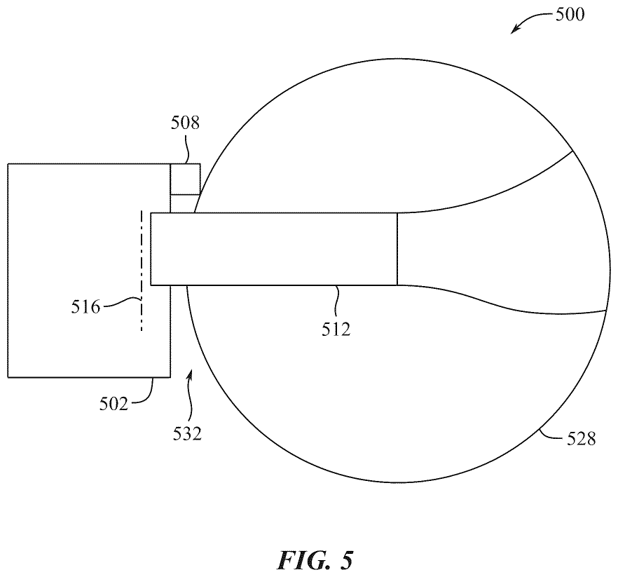

Any of the features, components, and/or parts, including the arrangements and configurations thereof shown in FIGS. 4A-4B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 4A-4B. Further examples of head-mountable display devices, including how different components relate to the user's head and the user experience are given below in reference to FIG. 5.

FIG. 5 shows another example of a head-mountable display device 500. The head-mountable display device 500 can be secured to a user's head 528, as shown in FIG. 5. In some examples, the head mountable display device 500 can include a display portion 502, a bumper 508, a lens 516 disposed within the display portion 502, and a securement arm 512. In some examples, the securement arm 512 and the bumper 508 can each be configured to support a portion of the weight of the head-mountable display device 500. The bumper 508 can be coupled to the display portion 502 and can extend from the display portion 502. In some examples, the bumper 508 can extend towards a user face beyond the lens 516. Additionally, the bumper 508 can contact at least a portion of the face of user's head 528. The bumper 508 can be composed of a material that causes friction between a portion of the user's head 528 and the bumper 508. For example, the bumper 508 can be composed of silicone, foam, polymers, composites, or other material or combinations thereof. In some examples, the bumper 508 can also be made from non-Newtonian fluid bladder to provide a soft and comfortable user experience under normal usage then become firm in response to an applied force. Friction between the bumper 508 and the user's head 528 can produce a force that supports the head-mountable display device 500. In some examples, the securement arm 512 can also be configured to support a portion of the weight of the head-mountable display device 500 by resting on a user's cars. In some examples, the bumper 508 can improve comfort by reducing the friction of the weight of the head-mountable display device 500 supported by a user's cars. Weight distribution provided by friction between the bumper 508 and the user's head 528 can contribute to the user's comfort and experience.

In some examples, portions of the bumper 508 can extend from the display portion 502 to define a gap 532 between the display portion 502 and the user's head 528. In some examples, the gap 532 can be an open space between a bumper and a nose piece. In some examples, the display portion 502 can define a first gap 532 on a first side of the user's head and a second gap 532 on a second side of a user's head. The gap 532 can allow ambient light to reach components of the display portion 502 or portions of the user's head 528, allowing an unobstructed peripheral viewing experience. For example, the gap 532 can allow ambient light to enter a field of view of the user. In other examples, the bumper 508 can be configured to block at least a portion of ambient light, shading at least the eyes of the user or any displays or lenses coupled to the display portion 502 from light sources above the user's head 528.

For example, a bumper 508 coupled to the display portion 502 above the eyes of the user can block light coming from above. A bumper 508 coupled to the display portion 502 around the eyes of the user can block ambient light coming from other directions. In some examples, the bumper 508 can be configured to define a gap 532 that can optimize light emanating from or through the display portion 502. For example, the gap 532 can be configured to affect the media displayed to the user from the display portion 502 and influence user experience. In other examples, the gap 532 can be configured to allow air flow across at least a portion of the user's head 528 otherwise covered by the display portion 502.

In some examples, portions of the bumper 508 can extend from the display portion 502 such that the bumper 508 does not contact the user's head 528. In such an example, the bumper 508 can still provide the functions taught above. A gap 532 can be defined by other features of the head-mountable display device 500, such as by a nose piece or securement arm 512. A gap 532 defined by other features of the head-mountable display device 500 can provide substantially similar benefits as the gap 532 describe above. In other examples, the bumper 508 can be configured as a light seal. The bumper 508 can be configured to block light from entering at least a portion of the field of view of a user when the head-mountable display device 500 is donned. In such examples, preventing light from entering the field of view of a user can enhance the visual experience provided by the head-mountable display device 500.

In some examples, a securement arm 512 can be configured to extend around at least a portion of the user's head 528. A securement arm 512 can be further configured to strategically contact at least a portion of the user's head 528. For example, securement arms 512 can be configured to rest on the cars of a user's head 528. In other examples, one or more securement arms 512 can be configured to attach to another head-mountable device or article, such as a hat or a cap. In some examples, one or more securement arms 512 can be configured to extend to the back of the user's head 528. In some examples, securement arms 512 can wrap around a user's head 528. In other examples, a securement arms 512 can wrap around a portion of a user's head 528. These examples can be configured to support the weight of the head-mountable display device 500 and can provide for a comfortable user experience.

Securement arms 512 can also be configured to hold a head-mountable display device 500 to the face of a user. Examples included above can be further configured to optimally hold the head-mountable display device 500 against the user's head 528. For example, a securement arm 512 can include a contractible feature that can pull the head-mountable display device 500 towards the user's head 528. For example, a contractible feature can include a spring or contractible band. In other examples, a protractible and retractable feature can be used. For example, a stretchable band, a ratchet mechanism, click adjustments, or adjustable sliders can be used. The securement arms 512 can be further configured to include one or more adjustment mechanism that modify the securement arms 512. Additionally, adjustment mechanisms included in the securement arms 512 can be configured to optimize the placement of head-mountable display device 500 and account for variations in the user's head 528. According to at least these examples, the securement arms 512 can be configured to optimally hold the head-mountable display device 500 against the user's head 528, despite variations in head shape sizes between different users.

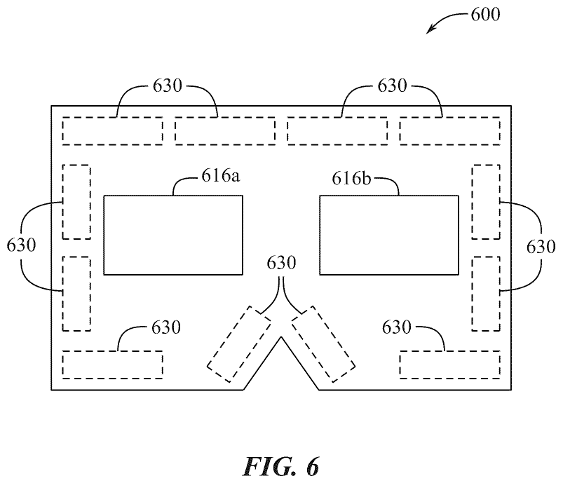

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, cither alone or in any combination, in the example of the devices, features, components, and parts shown in FIG. 5. More examples of display portions with attachment points are given below in reference to FIG. 6.

FIG. 6 shows another example of a display portion 600. The display portion 600 can include a first lens 616a and a second lens 616b. In some examples, at least one of the first lens 616a or the second lens 616b can be removable. In some examples, at least one of the first lens 616a or the second lens 616b can be a corrective lens.

The display portion 600 can further include one or more attachment points 630 or regions for receiving, for example removably securing, one or more bumpers to the display portion 600. A variety of attachment types, such as magnetic, snap attach, adhesive, screw, hook and loop, or other attachment mechanisms, can be used for attachment points 630. In some examples, the attachment points 630 can be distributed along a perimeter of the display portion 600. For example, the attachment points 630 can be distributed continuously along a perimeter of the display portion 600. In other examples, the attachment points 630 can be distributed discretely around a perimeter of the display portion 600 such that a gap exists between consecutive attachment points 630. In some examples, the attachment points 630 are disposed at locations other than around a perimeter of display portion 600. The attachment points 630 can be distributed on the display portion 600 for optimal attachment of components of the display portion 600. For example, the attachment points 630 can couple a bumper to the display portion 600 in an optimal or desired position. Variability in bumper placement can provide support for the display portion 600 and comfort to the user.

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, X® (formerly TWITTER®) ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A head-mountable display device, comprising:
a frame;
a display coupled to the frame;
a lens coupled to the frame adjacent the display; and
a facial interface extending from the frame;
wherein:
the facial interface includes a bumper and a nose piece;
the bumper includes a first portion and a second portion;
the first portion is more firm than the second portion; and
the lens is disposed between the nose piece and the bumper.

2. The head-mountable display device of claim 1, wherein the frame defines a gap between the facial interface and a user face when donned.

3. The head-mountable display device of claim 1, wherein the facial interface defines an open space along the frame between the bumper and the nose piece, the open space allowing ambient light to reach the lens.

4. The head-mountable display device of claim 1, wherein the bumper is configured to be intentionally removable.

5. The head-mountable display device of claim 1, wherein the bumper is adjustable relative to the frame.

6. The head-mountable display device of claim 1, wherein:
the bumper is a first bumper; and
the head-mountable display device further comprises a second bumper spaced apart from the first bumper and configured to be aligned with a zygomatic bone when the head-mountable display device is donned.

7. The head-mountable display device of claim 1, wherein the first portion abuts the second portion.

8. The head-mountable display device of claim 1, further comprising a gap defined between the first portion and the second portion.

9. The head-mountable display device of claim 1, wherein the bumper extends beyond the lens away from the frame.

10. A head-mountable device comprising:
a frame;
a lens coupled to the frame; and
a bumper coupled to the frame;
wherein:
the bumper is configured to be disposed above the lens when the head-mountable device is donned by a user;
the bumper defines a first portion, a second portion, and a third portion;
the third portion is softer than the first portion and the second portion; and
the third portion is disposed between the first portion and the second portion.

11. The head-mountable device of claim 10, wherein the bumper defines:
a first gap between the frame and a face of the user on a first side of the bumper through which light enters a field of view of the user when the head-mountable device is donned; and
a second gap between the frame and the face on a second side of the bumper opposite the first side and through which light enters the field of view of the user when the head-mountable device is donned.

12. The head-mountable device of claim 10, wherein at least one of the first portion or the second portion defines a gap between the head-mountable device and the user when donned.

13. The head-mountable device of claim 10, wherein the third portion at least partially overlaps at least one of the first portion or the second portion.

14. The head-mountable device of claim 10, wherein the first portion is disposed between at least some of the third portion and the frame.

15. The head-mountable device of claim 10, wherein the frame defines a first region configured to receive the bumper and a second region configured to receive the bumper.

16. A display portion for a head-mountable display device comprising:
a frame;
a lens secured to the frame; and
a facial interface including a first protrusion adjacent the lens and a second protrusion adjacent the lens and separate from the first protrusion;
wherein:
the lens is disposed between the first protrusion and the second protrusion; and
the first protrusion is more rigid than the second protrusion.

17. The display portion of claim 16, further comprising a third protrusion defined by the facial interface, the third protrusion being softer than at least one of the first protrusion or the second protrusion.

18. The display portion of claim 17, wherein the third protrusion is located adjacent to the first protrusion.

19. The head-mountable display device of claim 16, wherein at least one of the first protrusion or the second protrusion comprises a non-Newtonian fluid bladder.

20. The display portion of claim 16, further comprising a second display secured to the frame.
